(19) United States
(12) Patent Application Publication
(10) Pub. No.: US 2006/0019014 A1
(43) Pub. Date: Jan. 26, 2006

(54) Biscuit flatbread and method of making same

(75) Inventors: Jean A. Linforth, Chanhassen, MN (US); Cara A. Yarusso, Eagan, MN (US); Nancy A. Kratz, Clearwater, FL (US); Buffy B. Clark, Plymouth, MN (US); Randy S. Hasse, Waverly, MN (US)

Correspondence Address: GENERAL MILLS, INC., P.O. BOX 1113, MINNEAPOLIS, MN, 55440, US

(73) Assignee: General Mills Marketing, Inc.

(21) Appl. No.: 11/176,438

(22) Filed: Jul. 7, 2005

Related U.S. Application Data
(60) Provisional application No. 60/586,336, filed on Jul. 8, 2004.

(51) Int. Cl. A21D 10/00

(52) U.S. Cl. 426/549

(57) ABSTRACT

A method for manufacturing a freezer-to-oven biscuit flatbread. A continuous sheet of biscuit dough is perforated and sliced to form a perforated dough pad. The perforated dough pad is directed through a freezing tunnel to freeze the dough pad. The frozen dough pad is sufficiently rigid to facilitate packaging and storage. In addition, the frozen dough pad is easily separated or broken along the perforations to form frozen biscuit units. The frozen biscuit unit can be baked such that a baked biscuit unit can be prepared and consumed as a side item, a dessert item or as a sandwich carrier.

### PRIORITY CLAIM AND CROSS-REFERENCE TO RELATED APPLICATION

The present application claims priority to U.S. Provisional Patent Application No. 60/586,336 filed Jul. 8, 2004, entitled, “BISCUIT FLATBREAD AND METHOD OF MAKING SAME,” which is herein incorporated by reference to the extent not inconsistent with the present disclosure.

### FIELD OF THE INVENTION

The invention relates to a method for preparing biscuit flatbread. Specifically, the invention relates to a method for preparing a biscuit dough pad in a flatbread format that is easily packaged, stored, separated and baked for use as a food carrier or complementary side item.

### BACKGROUND OF THE INVENTION

Biscuits have been used as a food item for centuries. Early biscuits comprised unleavened, hard, thin wafers with a very low moisture content. These early biscuits could be stored for long periods of time due to their low moisture content. As such, biscuits often accompanied explorers around the world and could be stored for months at a time within airtight carriers. In its origin as a food type, biscuits were not a very appetizing food. Named “pain bis-cuit” or “twice cooked bread,” they originally were very hard and dry, and were especially useful to the traveler and the soldier because they were very light and did not spoil. Modern biscuits are more appetizing in that they are not twice baked to such a dry state. Modern biscuits are characterized by being prepared using chemical leavener(s) rather than yeast, and the biscuit dough is mixed only enough to incorporate all the ingredients without developing the gluten in the dough. The end product preferably has a light and moist crumb texture that has been described as flaky. The characteristic flavor of a biscuit is generally bland in nature.

Today's biscuits tend to be more moist and flaky and cookbooks include directions for making them as such. These biscuits tend to contain as much water as bread. The biscuit dough is mixed only enough to incorporate the ingredients while limiting the gluten development. Shortening is then added and kneaded into the dough. The biscuit dough is then rolled into a sheet and cut into desired units.

While methods for preparing biscuits have existed for centuries, it would be advantageous to have an method for manufacturing flatbreads from biscuit dough to provide a biscuit dough in a fast and convenient configuration that facilitates packaging, transport, shipping and baking.

### SUMMARY OF THE INVENTION

The invention addresses the aforementioned needs by providing a flavorful biscuit product, optionally incorporating one ore more flavors, and/or visual enhancing elements. Further, a method is provided for manufacturing and providing a freezer-to-oven biscuit flatbread. A continuous thinly sheeted biscuit dough is perforated and sliced to form an individually separable perforated dough pad. The perforated dough pad can be directed through a freezing process such as a freezing tunnel such that the dough pad is frozen. The frozen dough pad is sufficiently rigid to facilitate packaging and storage. In addition, the frozen dough pad is easily separated or broken along the perforations to form individual pieces of frozen biscuit units, where such units can be in a variety of shapes. The frozen biscuit unit can be baked such that a baked biscuit unit can be consumed as a side item, a dessert item or as a sandwich carrier. In some embodiments, the frozen biscuit unit can comprise a partially or par-baked biscuit unit that is at least partially cooked prior to freezing so as to reduce preparation time for a user.

In one aspect, the invention pertains to a method for preparing a biscuit flatbread dough pad. A method for preparing a biscuit flatbread dough pad can comprise: perforating a continuous thinly sheeted biscuit dough with at least one slitter to form at least one continuous perforated slit in the biscuit dough so as to define at least two attached biscuit flatbread units; and slicing the biscuit dough in an orientation generally transverse to the at least one continuous perforated slit, wherein a biscuit flatbread dough pad is separated from the continuous thinly sheeted biscuit dough.

In another aspect, the invention pertains to a method for preparing a biscuit flatbread. A method for preparing a biscuit flatbread can comprise: perforating a continuous sheet of biscuit dough with at least one slitter to form at least one continuous perforated slit in the biscuit dough; slicing the continuous sheet of biscuit dough in an orientation generally transverse to the at least one continuous perforated slit, wherein a pad of flatbread biscuit dough is separated from the continuous sheet of biscuit dough; freezing the biscuit flatbread dough pad to form a rigid, frozen dough pad adapted for packaging and storage; separating the rigid, frozen dough pad into at least two frozen flatbread biscuit units; and baking at least one of the frozen flatbread biscuit units to form a baked flatbread biscuit unit.

In a further aspect, a portioned biscuit flatbread dough product is provided. The dough product comprises a biscuit flatbread dough sheet formed in a generally rectangular shape, wherein the sheet comprises at least two biscuit flatbread dough units attached at a perforated slit.

The above summary of the various embodiments of the invention is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of an embodiment of a biscuit dough pad.

FIG. 2 is a perspective view of an embodiment of a biscuit dough pad.

FIG. 3 is a top view of an embodiment of an individual biscuit unit.

FIG. 4 is a top view of an embodiment of an individual biscuit unit.

FIG. 5 is a top view of an embodiment of an individual biscuit unit.

FIG. 6 is a schematic view of a process for forming a biscuit dough pad.

FIG. 7 is a perspective view of a freezable container filled with a plurality of frozen biscuit dough pads.

FIG. 8 is a top view of a plurality of individual biscuit units arranged in a baking implement.

FIG. 9 is a perspective view of an embodiment of a baked biscuit unit for use as a side items.

FIG. 10 is a perspective view of an embodiment of a baked biscuit unit for use as a sandwich carrier.

FIG. 11 is a perspective view of an embodiment of a multi-layer biscuit dough pad.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

As used herein, the term “unproofed” indicates that that a biscuit dough is provided in a state wherein it contains sufficient unactivated leavening agent that the biscuit product will at least double in volume when baked from the frozen state. Thus, while some chemical leavening agent may have interacted with ingredients in the dough process during mixing to generate some gases, a sufficient amount of the leavening agent is still available to be utilized to proof the dough during baking. The term “frozen” describes dough products that are maintained at a temperature below the freezing point of water, regardless of whether all ingredients in the dough product are actually in the frozen state.

As used herein, the term “dough pad” refers to an article that is in an intermediate condition and requires further thermal processing such as baking, microwaving, or the like, to fully cook the dough pad into a biscuit flatbread unit suitable for consumption by a consumer.

As used herein, the term “flatbread” refers to a thinly sheeted biscuit dough.

The biscuit dough is a dough comprising flour, water, chemical leavening system, sugar and fat, characterized by being an undeveloped or underdeveloped dough. The biscuit dough is prepared by mixing the dough composition only enough to incorporate all the ingredients without fully developing the gluten in the dough. As is appreciated by those of skill in the baking art, a biscuit dough is distinct from bread-like doughs due to the degree of development of the dough. Thus, a biscuit dough is stickier and it tends to break when stretched. A bread dough is typically more extensible than a biscuit dough. A tool to quantify the nature of the extent of development of the dough is a farinograph, which is a common flour and dough quality measuring device which measures the resistance of the dough to mixing. As dough is mixed, the resistance to mixing increases until a peak is reached, after which the resistance to mixing decreases. Typical bread doughs tend to peak within about 3 minutes, indicating that the dough is fully developed. A biscuit dough, in contrast, will take longer to reach a peak resistance, indicating that the dough is underdeveloped. Biscuit doughs typically reach a peak of resistance in a time period greater than about 7 minutes, and preferably greater than about 10 minutes. The biscuit dough is mixed using a mixer suitable for the size batch to be prepared.

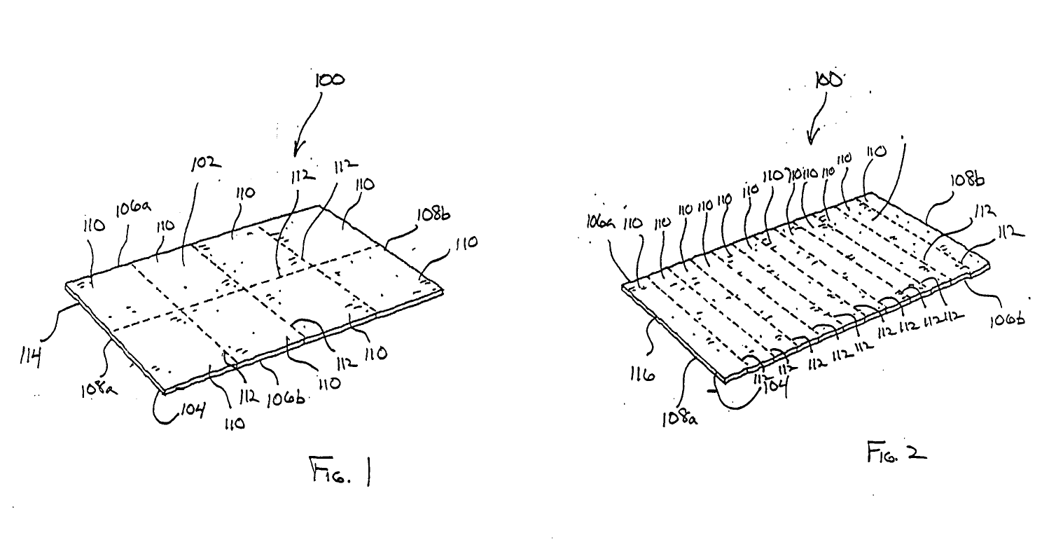

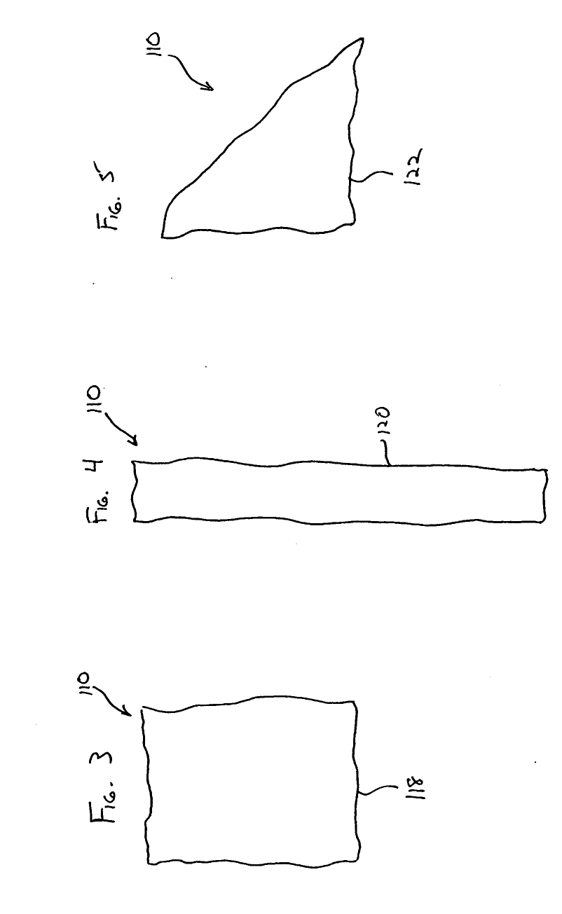

An embodiment of a biscuit dough pad 100 is illustrated in FIG. 1. Biscuit dough pad 100 generally comprises a first major surface 102, a second major surface 104, side surfaces 106a, 106b and end surfaces 108a, 108b. Biscuit dough pad 100 generally comprises a unitary structure of individual biscuit units 110 being partially defined and connected along perforated margins 112. Individual biscuit units 110 can comprise a variety of shapes dependent upon processing capabilities and end uses. Representative shapes for individual biscuit units 110 can comprise rectangles, squares, triangles and elongated or stick-like units as illustrated in FIG. 2. Biscuit dough pad 100 can comprise a wide variety of physical configurations based upon the number of attached biscuit units 110. In one representative example, biscuit dough pad 100 can comprise a 2×4 arrangement 114 of generally rectangular biscuit units as illustrated in FIG. 1. Another representative configuration for biscuit dough pad 100 can comprise a 1×12 arrangement 116 of stick-like biscuit units 110 as illustrated in FIG. 2.

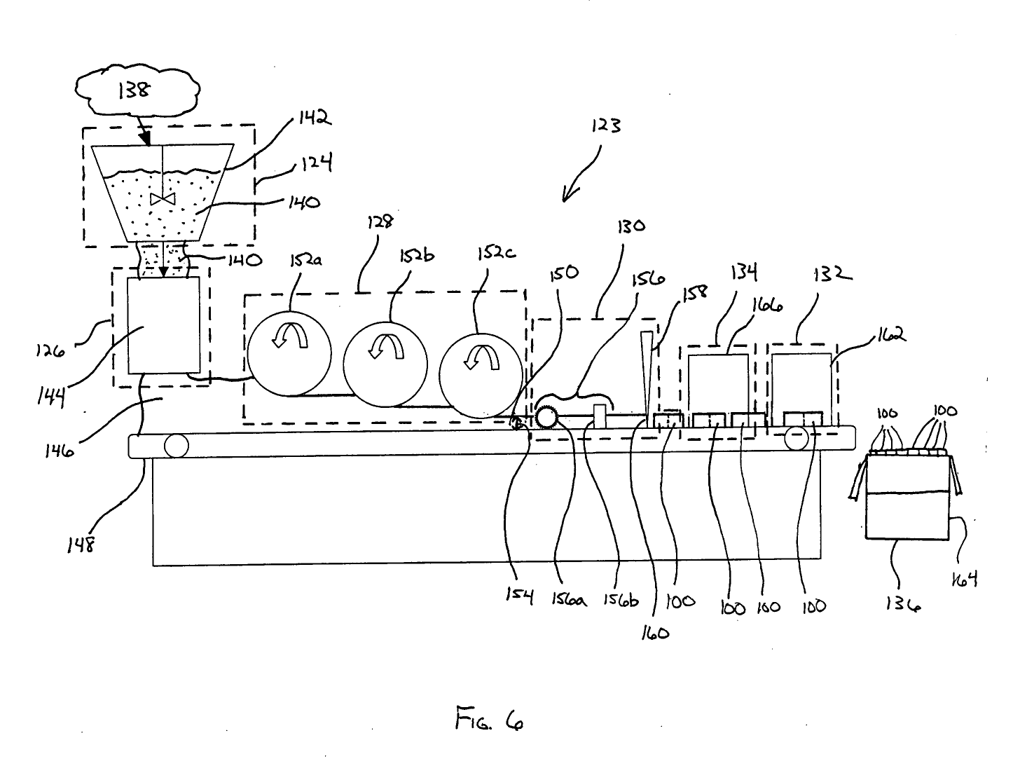

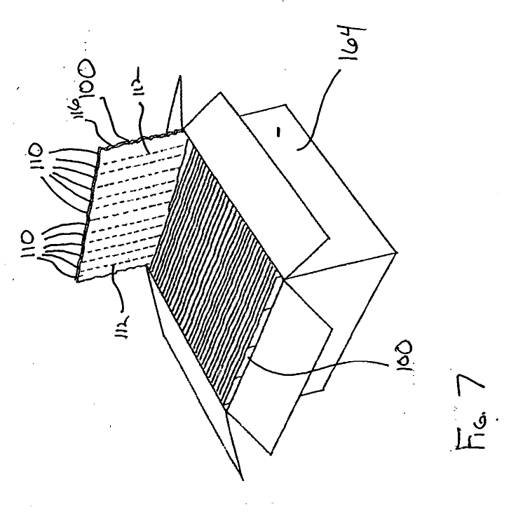

Various embodiments of individual biscuit units 110 are illustrated in FIGS. 3, 4 and 5. As illustrated in FIG. 3, individual biscuit unit 110 can comprise a generally rectangular configuration 118 corresponding to the 2×4 arrangement 114 illustrated in FIG. 1. Alternatively, individual biscuit unit 110 can comprise a generally stick-like configuration 120 as illustrated in FIG. 4 corresponding to the 1×12 arrangement 116 of FIG. 2. Finally, individual biscuit unit 100 can further comprise a generally triangular configuration 122 as illustrated in FIG. 5 or other suitable geometrical and shaped configurations based upon production capabilities and consumer requirements.

A representative method for forming dough pad 100 is illustrated schematically in FIG. 6. Dough pad 100 can be formed using a pad formation process 123 generally comprising a mixing stage 124, an extrusion stage 126, a sheet formation stage 128, a pad formation stage 130 and a freezing stage 132. In addition, pad formation process 123 can comprise additional optional processing steps such as, for example, a baking or par-baking stage 134 and a packaging stage 136. In addition, other optional process stages can be added to pad formation process 123 depending upon the desired characteristics of the end product. For example, pad formation process 123 can further comprise a dough stacking stage for forming a dough pad 100 that can ultimately be distinguished split and separated longitudinally upon final baking by a user.

As illustrated in FIG. 6, dough ingredients 138 are combined and mixed in mixing stage 124 to form a biscuit dough 140. Mixing stage 124 generally comprises adding dough ingredients 138 into a mixer 142 suitable for use in dough processing. Examples of suitable mixers 142 can comprise mixers available from the Hobart Corporation of Troy, Ohio.

Biscuit dough 140 can comprise a wide variety of dough ingredients 138 depending upon the desired properties such as, for example, taste and texture of a finished biscuit product. One representative biscuit dough 140 can be formulated to comprise dough ingredients 138 in the following amounts:

| Ingredient | Weight Percent |
|---|---|
| Flour | 40-50 |
| Salt | 0.5-1.5 |
| Water | 25-35 |
| Shortening | 10-20 |
| Leavening | 2-3 |

In addition to the ingredients recited above, biscuit dough 140 can comprise a wide variety of additional flavor(s) and/or visual enhancing elements. Representative examples of flavor(s) and/or visual enhancing elements can comprise shredded or grated cheese, sliced onions, sliced tomatoes, sliced green peppers, sliced red peppers, sliced jalapeno peppers, minced garlic or garlic powder, spices, seasonings, herbs, meat bits such as, for example, bacon bits, ham bits and sausage bits, fruit bits, sweetened bits, syrup bits, nut bits and a variety of fat or sugar based flavor bits having flavors such as, for example, fruit flavors, meat flavors, cheese flavors, gravy flavors, vegetable flavors, garlic flavor and pesto flavor. These additional flavor(s) and/or visual enhancing elements can be added to biscuit dough 140 as part of mixing stage 124, or alternatively, the flavor and/or visual enhancing elements can be added subsequently to mixing stage 124 so as to be externally visible on biscuit dough 140, for example, on first major surface 102 and/or second major surface 104.

Upon formation of biscuit dough 140 in mixing stage 124, biscuit dough 140 can be pumped and/or extruded in extrusion stage 126 with a suitable extruder 144. Representative extruders 144 for use with biscuit dough 140 can comprise extruders available from Bepex GmBh of Leingarten, Germany, Robert Reiser & Co., of Canton, Mass. and Albert Handtmann Holding Gmbh & Co. KG, of Biberbach, Germany. Extruder 144 extrudes biscuit dough 140 to create a dough stream 146 and directs dough stream 146 for transport using one or more dough transport mechanisms 148. Dough transport mechanism 148 can comprise one or more conveyors for transporting dough stream 146 through the additional stages of pad formation process 123. A representative dough transport mechanism 148 can comprise a conveyorized system such as, for example, conveyorized systems as disclosed in U.S. Pat. Nos. 6,561,235 and 6,838,105 to Finkowski et al., each of which is herein incorporated by reference to the extent not inconsistent with the present disclosure.

Dough transport mechanism 148 directs dough stream 146 through the sheet formation stage 128 to form a dough sheet 150 having a generally uniform thickness. Sheet formation stage 128 can comprise a plurality of rollers, for example a first roller 152a, a second roller 152b and a third roller 152c for sequentially rolling dough stream 146 to a desired sheet thickness 154 as dough transport mechanism 148 transports dough stream 146. As dough sheet 150 passes third roller 152c, sheet thickness 154 can range from about 1 mm to about 10 mm in thickness. More preferably, sheet thickness 154 can range from about 1 mm to about 6 mm in thickness. In a presently preferred embodiment, sheet thickness 154 can range from about 1 mm to about 5 mm in thickness.

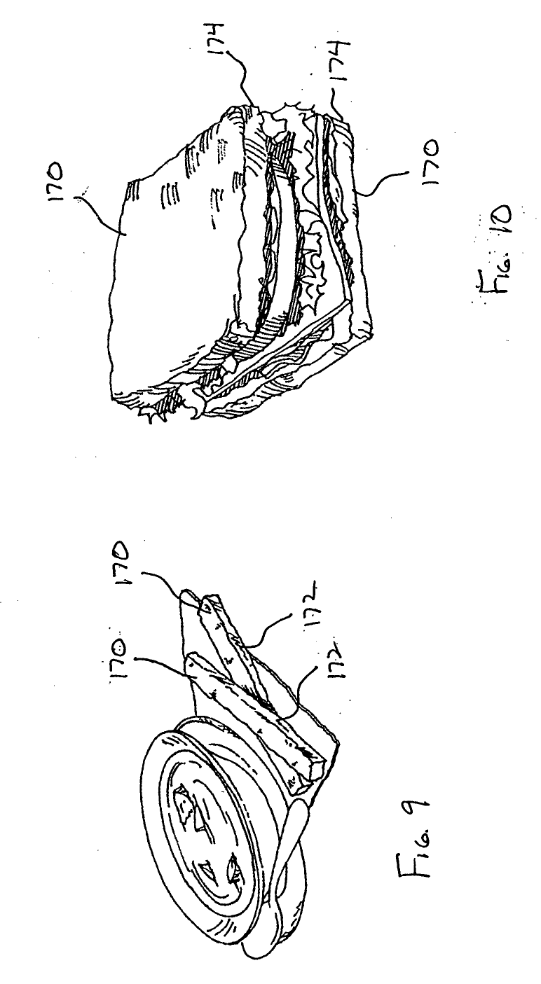

After the formation of dough sheet 150, dough transport mechanism 148 transports dough sheet 150 through the pad formation stage 130. Within pad formation stage 130, dough sheet 150 is processed to form dough pad 100 as well as the individual biscuit units 110 that comprise dough pad 100. Pad formation stage 130 generally comprises one or more perforating stages 156 as well as a cutting stage 158. As illustrated in FIG. 8, perforating stages 156 can comprise a first perforating stage 156a for perforating dough sheet 150 generally parallel to movement of dough transport mechanism 148 and a second perforating stage 156b for perforating dough sheet 150 in a generally transverse orientation to the movement of the dough sheet 150 along dough transport mechanism 148. First perforating stage 156a and second perforating stage 156b can both comprise multiple perforating devices such as, for example, rotary slitters.

Following the formation (defined by perforated slits) of individual biscuit units 110 in perforating stage 156, dough sheet 150 is directed by the dough transport mechanism 148 through cutting stage 158. Within cutting stage 158, a cutting member 160 cuts the dough sheet 150 in a direction generally transverse to the movement of dough sheet 150 along dough transport mechanism 148 so as to form individual dough pads 100. Cutting member 160 can comprise any suitable dough cutting member such as, for example, a rotary cutter, a guillotine cutter, an ultrasonic cutter, a wire cutter or any other suitable cutting instrument. As dough sheet 150 passes the cutting member 160, the cutting member 160 periodically slices dough sheet 150 resulting in the desired size and shape of dough pad 100.

After dough pads 100 have been formed in pad formation stage 130, dough transport mechanism 148 carries the dough pads 100 through the freezing stage 132. Freezing stage 132 can comprise a tunnel freezer 162 through which dough transport mechanism 148 transports the dough pads 100.

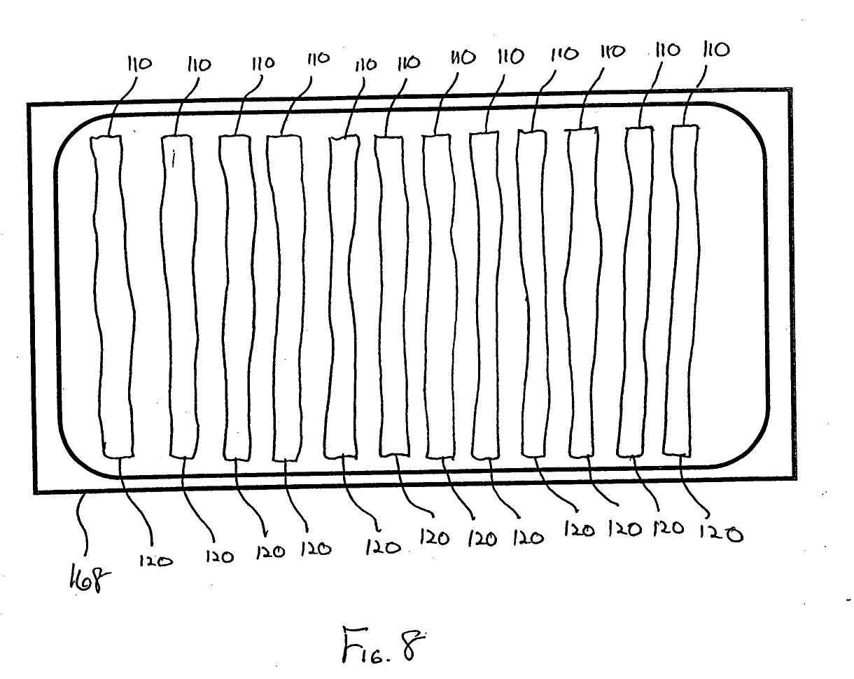

After exiting the freezing stage 132, the now frozen dough pads 100 can be transported by dough transport carrier 148 to packaging stage 136. In packaging stage 136, individual, or alternatively, a plurality, of dough pads 100 can arranged and placed in a suitable freezable container 164 such as, for example, a box as illustrated in FIG. 7. Freezable container 164 can comprise materials suitable for freezer storage including cardboard, paper and plastic, either individually or in combination. Each frozen dough pad 100 has enough strength and rigidity to survive storage and packaging while providing a convenient and easy method for separating each frozen dough pad 100 into individual biscuit units 110 by breaking each frozen dough pad 100 along perforated margins 112. After dough pads 100 have been packaged, freezable container 164 can be placed in cold storage and/or transported to a place of use.

In some instances, it may be advantageous to subject dough pad 100 to a baking process such as, for example, a partial or par-baking stage 134 prior to freezing the dough pads 100 within freezing stage 132 as illustrated in FIG. 6. In par-baking stage 134, the dough pads 100 are carried through a tunnel oven 166 such that the dough pads 100 are at least partially baked prior to being frozen. Through the use of a par-baking stage 134, preparation time by a user can be reduced as a portion of the required baking time has already been performed. This may be especially advantageous where dough pad 100 is used in the food service industry such as, for example, a commercial restaurant, cafeteria or bakery, wherein large volumes of dough pad 100 are typically consumed.

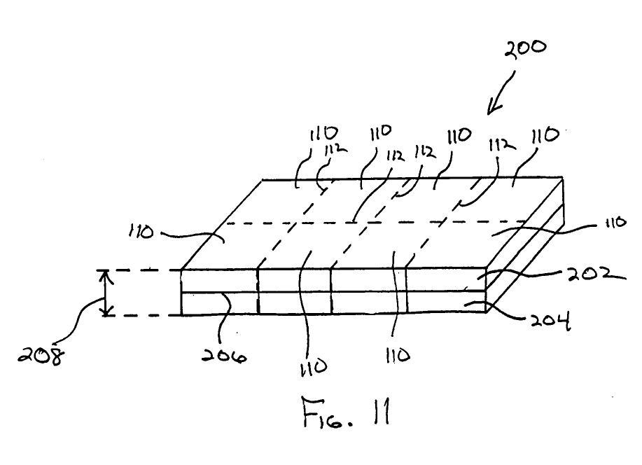

At time of use, dough pad 100, in either a frozen, refrigerated or tempered state, is separated along perforated margins 112 to form individual biscuit units 110. Once separated, individual biscuit units 110 can be individually arranged on a baking implement 168 such as, for example, a cookie sheet or pan as shown in FIG. 8. Baking implement 168 including individual biscuit units 100 is then placed into a baking instrument, such as a convection oven, toaster oven or conventional oven such that individual biscuit units 110 can be baked. In one representative embodiment, individual biscuit units 110 can be placed into a preheated baking instrument set at 325° F. for a period of 8 to 10 minutes such that the individual biscuit units reach an internal temperature of about 200° F. Upon completion of the baking process, a cooked biscuit flatbread unit 170 is ready for use and consumption. For example, cooked biscuit flatbread unit 170 can be served individually as a biscuit stick or side item 172 as shown in FIG. 9. Alternatively, a pair of cooked biscuit flatbread units 170 can be utilized as a sandwich carrier 174 in preparing sandwiches as shown in FIG. 10. Depending upon the amount and type of flavorings used in forming dough pad 100, the cooked biscuit flatbread units 170 may be suitable as either a breadbasket or dessert item.

In another representative embodiment, a multi-layer dough pad 200 can be formed so as to have a top dough layer 202 and a bottom dough layer 204 with a fat layer 206 located therebetween as illustrated in FIG. 11. Fat layer 206 can comprise a suitable fat source such as, for example, a liquid fat source such as soybean oil or cotton seed oil. Top dough layer 202 and bottom dough layer 204 can comprise an identical dough formulation such as, for example, a representative dough formulation as previously described with respect to biscuit dough 140. Multi-layer dough pad 200 can substantially resemble the appearances previously depicted and described with respect to dough pad 100 with the exception that multi-layer dough pad 200 can comprise a pad thickness 208 greater than previously described with respect to sheet thickness 154. Multi-layer dough pad 200 can be formed through a process similar to pad formation process 123 with the further inclusion of an optional stacking stage between sheet formation stage 128 and pad formation stage 130. In a representative stacking stage, liquid fat is applied on a top surface of bottom dough layer 204 and the top dough layer 202 is stacked on top the liquid fat to form fat layer 206 distinguishing top dough layer 202 from bottom dough layer 204. Top dough layer 202 and bottom dough layer 204 can comprise similar dough compositions as previously described with respect to doughpad 100. Multi-layer dough pad 200 can be frozen, packaged and prepared similarly to previously described dough pad 100. During baking of multi-layer dough pad 200, top dough layer 202 and bottom dough layer 204 split at fat layer 206 to form a baked top biscuit and a baked bottom biscuit for use and consumption by a consumer as previously described.

Although various embodiments of the invention have been disclosed here for purposes of illustration, it should be understood that a variety of changes, modifications and substitutions may be incorporated without departing from either the spirit or scope of the present invention.

What is claimed:

1. A method for preparing a biscuit flatbread dough pad comprising:
perforating a continuous thinly sheeted biscuit dough with at least one slitter to form at least one continuous perforated slit in the biscuit dough so as to define at least two attached biscuit flatbread units; and
slicing the biscuit dough in an orientation generally transverse to the at least one continuous perforated slit, wherein a flatbread biscuit dough pad is separated from the continuous thinly sheeted biscuit dough.

2. The method of claim 1, further comprising:
freezing the flatbread biscuit dough pad to form a rigid, frozen biscuit flatbread dough pad adapted for packaging and storage.

3. The method of claim 1, wherein perforating the continuous thinly sheeted biscuit dough comprises perforating a plurality of continuous perforated slits in the biscuit dough so as to define at least three attached biscuit flatbread units.

4. A method for preparing a flatbread biscuit comprising:
perforating a continuous sheet of biscuit dough with at least one slitter to form at least one continuous perforated slit in the biscuit dough;
slicing the continuous sheet of biscuit dough in an orientation generally transverse to the at least one continuous perforated slit, to separate a pad of flatbread biscuit dough from the continuous sheet of biscuit dough;
freezing the biscuit flatbread dough pad to form a rigid, frozen dough pad adapted for packaging and storage;
separating the rigid, frozen dough pad into at least two frozen flatbread biscuit units; and
baking at least one of the frozen flatbread biscuit units to form a baked flatbread biscuit unit.

5. The method of claim 4, wherein perforating the continuous sheet of biscuit dough includes a plurality of slitters perforating a plurality of continuous slits in the biscuit dough.

6. A sandwich carrier formed by the method of claim 4.

7. A soup topper formed by the method of claim 4.

8. A dessert item formed by the method of claim 4.

9. A portioned biscuit flatbread dough pad comprising:
a biscuit flatbread dough sheet formed in a generally rectangular shape, wherein the sheet comprises at least two biscuit flatbread dough units attached at a perforated slit.

10. The dough pad of claim 11, wherein the at least two flatbread units have a shape selected from the group comprising: a square, a rectangular, a triangular and a stick-like form.

11. The dough pad of claim 11, wherein the biscuit dough sheet includes at least one flavor enhancing element.

12. The dough pad of claim 13, wherein the at least one flavor enhancing element is selected from the group comprising: shredded cheese, grated cheese, sliced onions, sliced tomatoes, sliced green peppers, sliced red peppers, sliced jalapeno peppers, minced garlic, garlic powder, spices, seasonings, herbs, meat bits, fruit bits, sweetened bits, syrup bits, nut bits, fat bits and sugar bits.

13. The dough pad of claim 11, wherein the biscuit dough sheet includes a visual enhancing element.

14. The dough pad of claim 11, wherein the perforated slit provides a rigid connection between the at least two flatbread units such that the generally rectangular shape is maintained during packaging, shipment and storage.

15. The dough pad of claim 11, wherein the biscuit dough sheet has a dough thickness from about 1 mm to about 10 mm.

16. The dough pad of claim 17, wherein the biscuit dough sheet has a dough thickness from about 1 mm to about 6 mm.

17. The dough pad of claim 18, wherein the biscuit dough sheet has a dough thickness from about 1 mm to about 5 mm.

18. The dough pad of claim 11, wherein the biscuit dough sheet comprises a top dough layer, a bottom dough layer and a fat layer located there between.

19. The dough pad of claim 20, wherein the fat layer comprises a liquid fat selected from the group comprising: soybean oil and cottonseed oil.

20. The dough pad of claim 11, wherein the biscuit dough sheet comprises a par-baked biscuit dough sheet.
